(19) United States
(12) Patent Application Publication
(10) Pub. No.: US 2003/0174178 A1
(43) Pub. Date: Sep. 18, 2003

(54) System for presenting differentiated content in virtual reality environments

(76) Inventor: Matthew Erwin Hodges, Cambridge, MA (US)

Correspondence Address: MATTHEW E. HODGES, 23 REED STREET, CAMBRIDGES, MA, 02140, US

(21) Appl. No.: 10/354,716

(22) Filed: Jan. 30, 2003

Related U.S. Application Data
(60) Provisional application No. 60/352,640, filed on Jan. 31, 2002.

(51) Int. Cl. G09G 5/00

(52) U.S. Cl. 345/848

(57) ABSTRACT

Virtual Reality Environments are typically represented in exactly the same manner to all participants, with variation according only to position and point of view of each participant. Systems and methods are disclosed herein for differentiating portions of the content of a virtual reality environment and of supplemental material presented in conjunction with the environment based on group membership. This invention relates to application of virtual reality techniques for the promotion and sale of goods, services, and incentives, where group membership based on language, affiliation, interest, behavior, or other such criteria may be used as a basis for differentiating the representation of the environment, it's contents, participants, or other supplemental materials.

### FIELD OF THE INVENTION

The present invention relates generally to systems designed for the promotion of goods, services, and incentives, and to systems for electronic shopping. Within this field, it focuses on the use of an interactive graphical representation of a real or imagined environment (virtual reality) as a venue for conducting electronic commerce and the related activities of promotion, presentation of incentives, and communication between seller and potential buyer.

An interactive graphical representation of a real or imagined physical space is herein referred to as a “virtual reality.” The term “interactive” in this context implies that the user may control or change their view of the environment in such a way as to simulate continuous or quasi-continuous movement through the represented space, or otherwise simulate a change of position within the represented space,. or to simulate changing the direction or field of view within the represented space. There may be other aspects of control or manipulation within such a system, but user control of viewpoint is the defining characteristic with respect to this invention.

There is substantial prior art demonstrating the use of such a virtual reality system as a venue for conducting electronic commerce by providing a representation of a “virtual store” wherein users could select and purchase products represented in the store (Apple Computer). Similarly, there is substantial prior art describing and demonstrating the use of a virtual reality environment to represent a corresponding real commercial space (Aspen project). Furthermore, there is substantial prior art demonstrating the use of a virtual reality system as a means of conducting guided tours of physical spaces, as well as for general communication among simultaneous users of a virtual reality system.

Other patents have made claim to various systems or methods of producing interactive graphical representations of environments or control systems used in virtual reality systems. Still other patents have made claim to systems or methods for the promotion of goods and services through electronic games, which in some cases share the defining characteristics of virtual reality systems as the term is used here.

Within this context, the scope of the present invention encompasses a systematic organization of processes and methods that facilitate the use of such a representation as a shared venue for conducting commercial transactions and marketing communication between a plurality of buyers and sellers.

Of particular importance are:

a.) those aspects of the invention that permit a plurality of sellers of goods and services to manage product offerings, promotions, and marketing communication within the virtual reality environment; and

b.) those aspects of the invention which permit a plurality of agencies or institutions to represent the virtual environment in differentiated form by means of added, modified, or deleted content, within the context of Internet-based publications they may produce.

### BACKGROUND OF THE INVENTION

Electronic commerce and the promotion of goods and services over public-accessible wide area networks (such as “the Internet”) have developed dramatically over the past few years. A very few distinct patterns of usage represent the bulk of this activity. The promotion of goods and services through network-based publications generally takes the form of so-called “banner advertisement” or “tiles” placed on the pages of high-traffic network publications, designed to entice potential customers to “click through” from the advertisement back to the seller's own promotional publication.

The standard pattern for electronic commerce is to offer merchandise through an “electronic catalog,” by either developing a catalog on the seller's network-based publication, or by inserting products into a shared catalog on an electronic auction system. In either case, the electronic catalog comprises a list of product descriptions, usually presented in text form, with associated images or video for illustration, along with pricing and other order information.

Both of these patterns of usage are based roughly on familiar formats drawn by analogy from the world of conventional paper-based publishing.

The present invention arose from a publishing enterprise originally based on this conventional framework. The intent was to use well-established virtual reality technology to create a new form of online venue focused on travel and culture. The goal was to acquire a large audience and derive revenues from “click-through” advertisement and direct catalog-based sales, although from the beginning there was a notion that the virtual reality environment could be used as a venue for product transactions in a departure from the standard catalog format following the example of Apple Computer.

The present invention was founded in the realization that the virtual reality content being produced was an asset with value to many electronic publishers in the travel and tourism industry and other commercial enterprises. With proper development this asset could be distributed in the form of a “shared virtual reality” that could be differentiated through the addition of customer-specific content and inserted as an added-value service into many publications.

This strategy was seen as a way to carry a package of promotional material and product merchandising opportunities to an audience of potential customers through a large number of customized publications rather than through a single monolithic branded point of entry as is typical with Internet publications. Many other significant advantages were seen in the ability to vary content based on group membership. These observations lead to the idea that many sellers could share such a resource as a venue for conducting electronic commerce, but that specialized systems and methods would be required to enable them to insert and manage their product offerings and promotional content within the context of a shared virtual reality environment.

The methods and processes central to this invention are those which govern the differentiation of the shared virtual reality environment, the insertion and management of differentiated advertising content and product representations, and the representation and management of channels of communication between buyer and seller.

### SUMMARY OF THE INVENTION

The present invention comprises a system of methods and processes which enable the virtual reality environment to be used as a shared venue for product description and promotion, presentation of incentives, customer communication, and electronic sale of goods and services. The elements of the invention pertain to the implementation of four fundamental services:

differentiation of the virtual reality environment, such that different inserted and supplemental content may be displayed to different buyers or groups of buyers based on group affiliation;

customer communication within the virtual reality environment, such that buyers and sellers may detect the presence of one another within the environment, initiate communication with other individuals or groups, and engage in coordinated “movement” through the environment (where movement refers to change of location or direction of view within the simulated environment);

product catalog management, such that sellers can manage the dynamic insertion and representation of products within the graphic representation of the virtual reality environment;

distributive transaction management, such that cooperative marketing agreements may be implemented among a plurality of sellers, allowing them to divide and distribute incentives, credits, or the proceeds from transactions based on the group affiliation(s) of a buyer.

The claims set forth in the present invention are made for systems comprising various combinations of one or more of these various elements.

### 1.0 Differentiation

1.1. Group Affiliation Codes

1.1.1. Methods are disclosed which are used to assign “group affiliation codes” to individual “buyers.” The term “group affiliation code” refers to a symbol or set of symbols which may be associated with a subset of one or more visitors engaged in using the Virtual Reality Environment and which may be used thereafter used to uniquely identify those visitors as members of a group sharing some characteristic or trait. The term “buyers” refers herein to those persons entering into the published virtual reality environment in the role of potential buyers of goods and services, who may be engaged in exploratory behaviors or in behaviors associated with a directed search for or the acquisition of products, services, or incentives. Various methods are used to assign group affiliation codes to buyers based on passive behaviors, such as point-of-entry or point-of-passage, or though active behaviors they may initiate, such as choices or selections made during the course of controlled interaction within the virtual reality environment.

1.1.2. Methods are disclosed which are used to maintain or then to terminate the association between a particular buyer and a group affiliation code. Maintaining group affiliation code assignments is accomplished by various means; these may include such mechanisms as a code stored in temporary file on the buyer's computer (so-called “cookie”), or as a code attached directly to the buyer's transmissions passed to and from the virtual reality environment server. Termination of code associations may also be effected by various means; these may be based on passive behaviors such as simple movement outside of a specified range within the virtual reality environment, or on active behaviors such as buyer selecting a “close” or “discard” option.

1.2 Presenting Inserted and Supplemental Content Based on Group Affiliation Code

1.2.1 Methods are disclosed which are used to control the display of inserted and supplemental content based on group affiliation codes. The term “inserted” refers to content which is integrated directly into the graphical representation of the virtual reality environment; “supplemental” refers to content which is displayed beside or otherwise in combination with, but not embedded within this graphical representation. Supplemental content may include descriptive text, logos, branding, or other combinations of imagery, sound, text, or video.

Various event, such as a buyer changing position or viewing angle within the virtual reality environment, may trigger a series of redisplay processes which generate a revised representation of the virtual reality environment and supplemental content. These redisplay processes make reference to the group affiliation codes to determine the display of inserted content.

1.2.2. A system of “custom display templates” is disclosed that is used to structure the presentation of the virtual reality environment and its associated supplemental content. These custom display templates are associated with group affiliation codes, which are used to determine the selection of content elements of the display.

1.2.3. Methods are disclosed which are used to integrate the inserted and supplemental content within the graphic representation of the virtual reality environment and its associated supplemental display.

1.3. Associating Group Affiliation Codes With Sellers

1.3.1. Methods are disclosed which are used to associate group affiliation codes with particular “sellers.” The term sellers is used here to refer to persons or agencies who are granted the ability to create or modify inserted or supplemental content associated with the virtual reality environment for purposes of product description, promotion, presentation of incentives, or communication with customers concerning any of these activities. Group affiliation codes are used by sellers to determine which groups of buyers are presented with specific inserted or supplemental content. Each seller may be associated with one or more group affiliation codes, and may have the ability to generate additional codes or to expire or delete group affiliation codes.

1.3.2. Methods are. disclosed which allow sellers to create, modify, or delete inserted or supplemental content based on group affiliation codes. These include “proximity-based” editors which allow sellers to move to a location within the virtual reality environment to place or edit inserted content.

1.3.3. Additional methods are disclosed which allow sellers to position and manipulate certain graphical types of inserted content within the graphical representation of the virtual reality environment.

### 2.0 Customer Communication

2.1. Representation of Visitors (Buyers and Sellers) in the Virtual Reality Environment

2.1.1. Methods are disclosed which are used to assign unique visitor identification codes (VIC) to buyers and sellers within the virtual reality environment. Visitor identification codes are symbols or sets of symbols which may be used to encode or make reference to information associated with an individual user of a virtual reality system.

2.1.2. Methods are disclosed which allow visitor identification codes to be associated with a location specification defining the visitor's current position within the virtual reality environment.

2.1.3. Methods are disclosed which allow visitors under certain conditions to grant or revoke permission to view or to reveal information associated with their visitor identification code to other visitors engaged in using the virtual reality system;

2.1.4. Methods are disclosed which control the graphical representation of visitors within the virtual reality environment.

2.2. Virtual Agents

2.2.1. Methods are disclosed which allow visitors to create, modify, or delete definitions of virtual agents. A virtual agent is a graphic representation of a person, agent, or being, real or imaginary, integrated within the representation of the virtual reality environment and which is capable of action or change. Definitions may specify combinations of text, graphic imagery, audio, or video information used to display, describe, or control the behaviors of a virtual agent.

2.2.2. Methods are disclosed by which actions and behaviors may be associated with virtual agents. Virtual agents may be programmed to interact with visitors in the environment in various ways such as displaying an animation, text message, or initiating a communication channel with one or more other sellers or buyers.

2.2.3. Methods are disclosed by which virtual agents may be associated with one or more group affiliation codes, such that they are visible or modify their behavior selectively to address different groups of buyers identified by said group affiliation code.

2.2.4. Methods are disclosed which allow authorized visitors to place, manipulate, or move a graphic representation of a virtual agent within the graphic representation of the virtual reality environment or associated map;

2.3. Instant Messaging

2.3.1 Methods are disclosed which allow buyers or sellers to initiate two-way or multi-way communication channels with one another and transmit messages in the form of text, audio, or video to other participants in the connection;

2.3.2 Methods are disclosed which allow the management of multiple channels of communication using a network-based server communicating with network-based clients using visitor identification codes for addressing and delivery of messages;

2.3.3 Methods are disclosed which allow sellers to associate an instant messaging client console with one or more virtual agents in the virtual reality environment, such that they receive messages directed to those virtual agents. Multiple sellers may be associated with a single virtual agent in order to facilitate a customer service center with multiple operators receiving messages directed through a single representation of a virtual agent within the environment. Additional methods are disclosed which allow such operators to segregate independent conversations with buyers and transfer them to other operators.

2.4. Guided Tours

2.4.1. Methods are disclosed which allow an authorized operator to transmit signals to one or more visitor consoles causing the visitors' positions and viewpoints within the virtual reality environment to change to a specified location and viewpoint and according to the display requirements of an associated group affiliation code. These methods allow a seller to guide visitors through the virtual reality environment.

2.4.2. Methods are disclosed which allow a visitor engaged in using the virtual reality environment to selectively protect their location and viewpoint within the virtual reality environment against change by other visitors.

### 3.0 Product Catalog Management

Product catalog management is an activity of central importance to the use of the differentiated virtual travel environment as a venue for commercial transaction.

3.1. Methods are disclosed which are used to allow sellers to create product descriptions and to define groups of such product descriptions. Descriptions may include combinations of text, graphical, video, and audio elements. Product descriptions may be associated with group affiliation codes such that different pricing, availability, or other descriptive information may be presented to different buyer groups based on group affiliation codes.

3.2. Methods are disclosed which are used to allow sellers to associate or dissociate groups of product descriptions with a specific location or proximity within the virtual reality environment.

3.3. Methods are disclosed which are used to allow sellers to place and manipulate representations of products within the graphic representation of the virtual reality environment.

3.4. Methods are disclosed which are used to associate product groupings with group affiliation codes such that product representations within the virtual reality environment are displayed to different groups of buyers based on group affiliation codes.

3.5. Methods are disclosed which are used to allow buyers to select product representations and retrieve supplemental descriptive information. These methods make reference to group affiliation codes to determine the descriptive elements which are presented to the buyer.

### 4.0 Distributive Transaction Management

4.1 Methods are disclosed which allow sellers to implement cooperative marketing relationships based on the group affiliation codes of the buyer. These methods allow sellers to distribute incentives, such as discount offers, to buyers based on group affiliation code. In addition, sellers may offer credits or distribution of payments to other sellers based on group affiliation codes of the buyer. For example, Seller A of tour services may offer payments to Seller B of accommodation services in cases where Seller A's customer has entered the virtual environment in connection with Seller B's hotel.

### BRIEF DESCRIPTION OF THE DRAWINGS

FIG. 1 is a schematic block diagram illustrating a shared virtual reality management system representative of the present invention;

FIG. 2 is a schematic block diagram of the exemplary central controller of FIG. 1;

FIG. 3 illustrates a sample set of tables from the Virtual Reality Environment database of FIG. 2;

FIG. 4 illustrates a sample set of tables from the Group Affiliation Code database of FIG. 2;

FIG. 5 illustrates a sample set of tables from the Seller database of FIG. 2;

FIG. 6 illustrates a sample set of tables from the Custom Display database of FIG. 2;

FIG. 7 illustrates a sample set of tables from the Buyer database of FIG. 2;

FIG. 8 illustrates a sample set of tables from the Transaction database of FIG. 2;

FIG. 9 illustrates a sample set of tables from the Communications database of FIG. 2;

FIG. 10 illustrates the Processes for Inserting Content Into the Virtual Reality Environment of FIG. 2;

FIG. 11 illustrates the Processes for Creating and Monitoring Virtual Agents Within the Virtual Reality Environment of FIG. 2;

FIG. 12 illustrates the Processes for Rendering the Virtual Reality Environment of FIG. 2;

FIG. 13 illustrates the Processes for Communicating Within the Virtual Reality Environment of FIG. 2.

### DETAILED DESCRIPTION

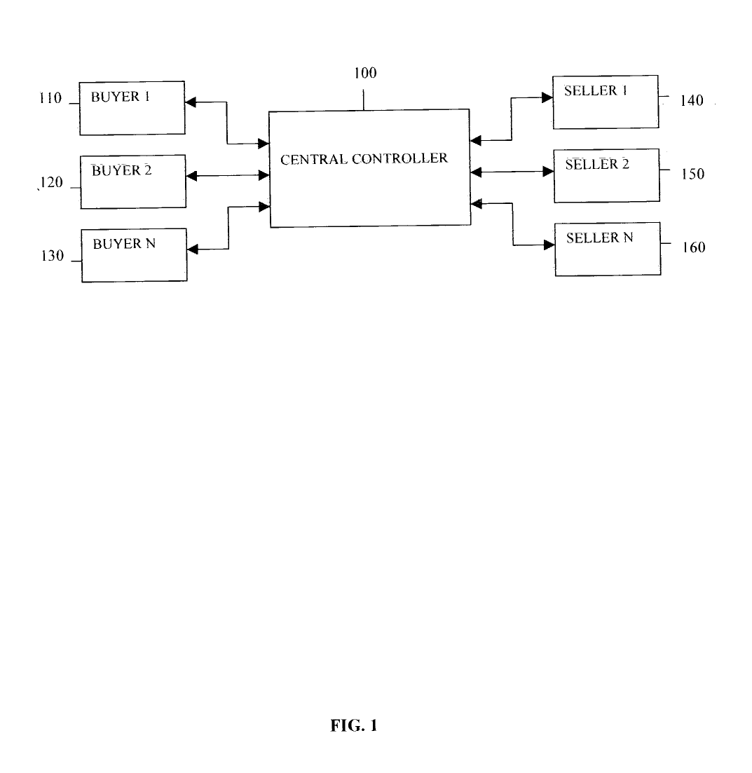

FIG. 1 shows a system for managing the presentation of differentiated virtual reality environments (VRE) 100 with integrated communication and product catalog features. The system receives requests for graphical representations from buyers 110, 120, 130 and requests for customization and content management from sellers 140,150,160.

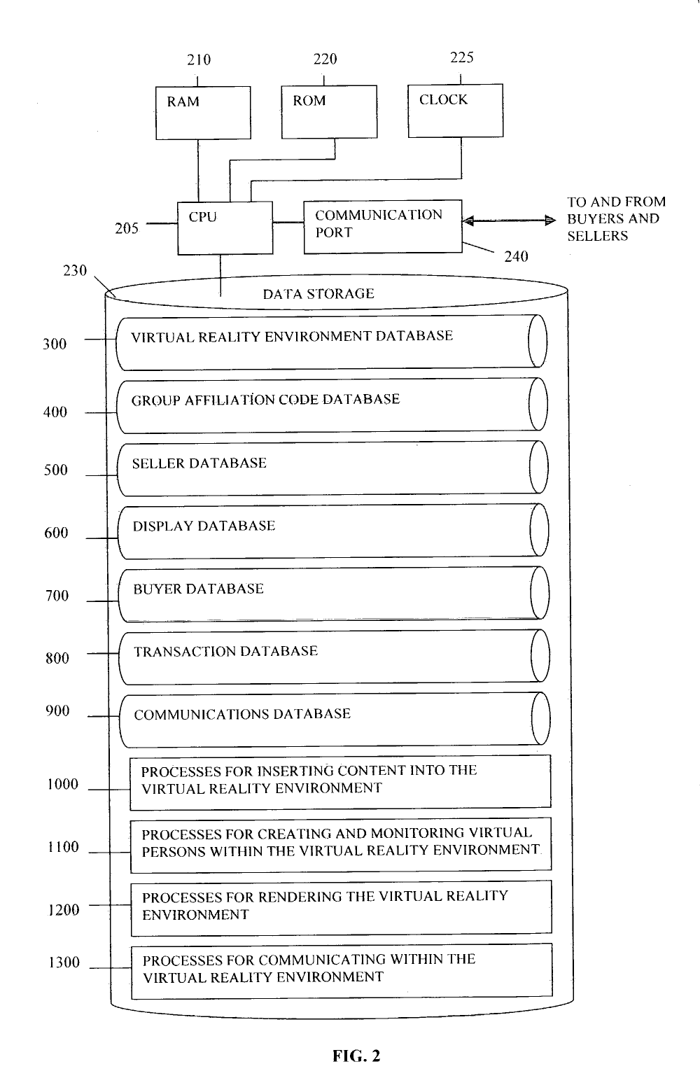

FIG. 2 is a block diagram showing the architecture of an illustrative central controller 100. The central controller 100 includes certain standard hardware components, such as a central processing unit (CPU) 205, a random access memory (RAM) 210, a read only memory (ROM) 220, a clock 225, a data storage device 230, and a communications port 240. The CPU 205 can be linked to each of the other listed elements, either by means of a shared data bus, or dedicated connections, as shown in FIG. 2. The communications port 240 connects the central controller 100 to each buyer 110 and seller 130 and optionally to remote credit or transaction processing servers. The communications port 240 can include multiple communication channels for simultaneously establishing a plurality of connections.

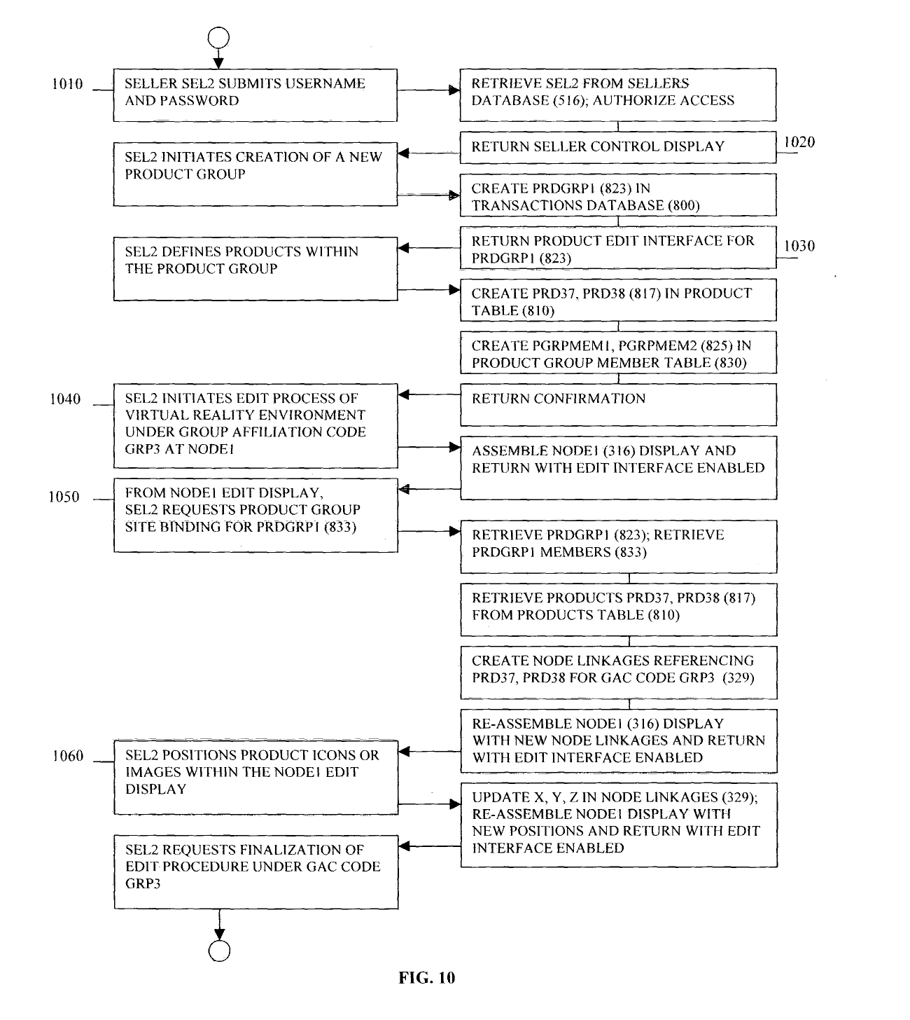

The ROM 220 and/or data storage device 230 are operable to store one or more instructions, discussed further below in conjunction with FIGS. 10 through 13, which the CPU 205 is operable to retrieve, interpret and execute. For example, the ROM 220 and/or data storage device 230 can store processes to accomplish the retrieval, composition, and delivery of graphic scenes with inserted content and supplemental material to sellers 130 and buyers 110.

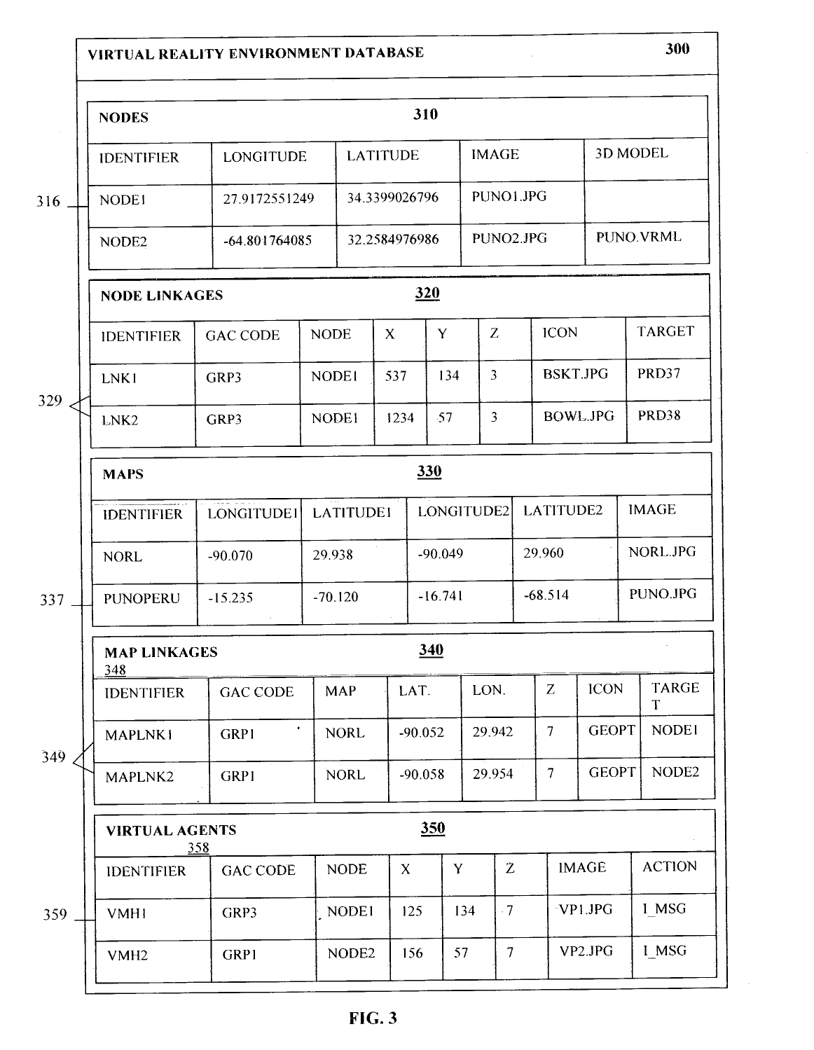

As discussed further below in conjunction with FIGS. 3 through 9, respectively, the data storage device 230 includes a Virtual Reality Environment database 300, a Group Affiliation Code database 400, a Seller database 500, a Display database 600, a Buyer database 700, a Transaction database 800, and a Commnication Link database 900.

FIG. 3. The Virtual Reality Environment (VRE) database 300 stores information defining all of the discrete loci, or nodes 310, of the virtual reality environment within the VRE system, including geographic coordinates as well as the information required to generate a representation of the environment at that location. The virtual reality environment database also stores information defining connections 320 linking any given location to other locations within the virtual environment and to other information resources within the VRE system accessible from that location, including representations of any objects, product descriptions, or virtual agents within the representational bounds of that locus.

The virtual reality environment database also stores information describing all resources used to generate cartographic or isomorphic representations of the virtual reality environment in whole or part 330, as well as the connections 340 from such representations to other information resources within the VRE system 100. Buyers 110, 120, 130 may use these connections to control their movement through the virtual reality environment or to access other information resources including object representations, product descriptions, and virtual agents.

The virtual reality environment database also stores information defining all representations of virtual objects and virtual agents within the VRE system 350, including location, orientation, and other transitory state information. This database is used to generate a representation of the virtual agent or object by means of graphic imagery, motion video, and/or sound.

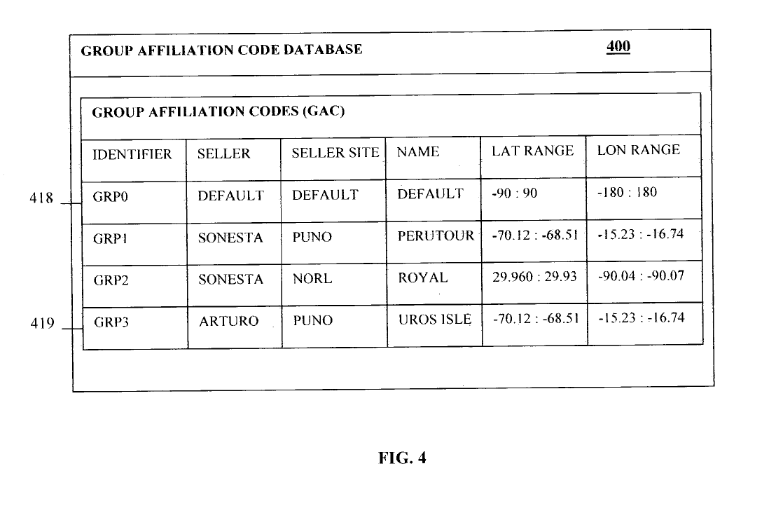

FIG. 4. The Group Affiliation Code (GAC) database 400 stores information defining all of the group affiliation codes that may be assigned to a buyer 110, 120, 130. These group affiliation codes are used as the basis of selection in the generation of representations of the virtual reality environment and auxiliary information at any given location.

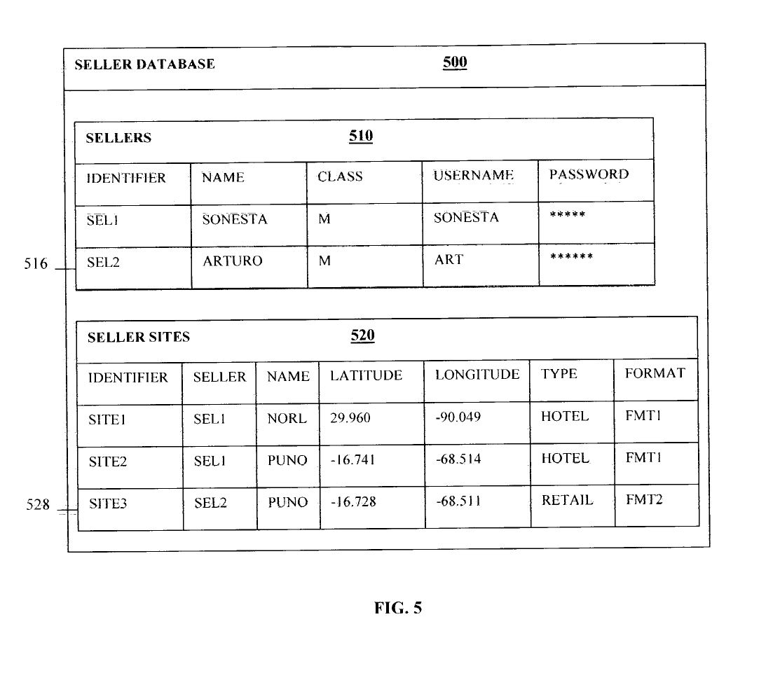

FIG. 5. The Seller database 500 stores information on each seller 140, 150, 160 which is registered with the VRE system 100 to sell products or to represent goods and/or services to buyers, including contact information and username and password 510.

The Seller database 500 also stores information on each location or venue within the virtual reality environment associated with each seller 140,150,160, including contact information and type of venue, as well as metric and descriptive information pertinent to each type of location or venue 520.

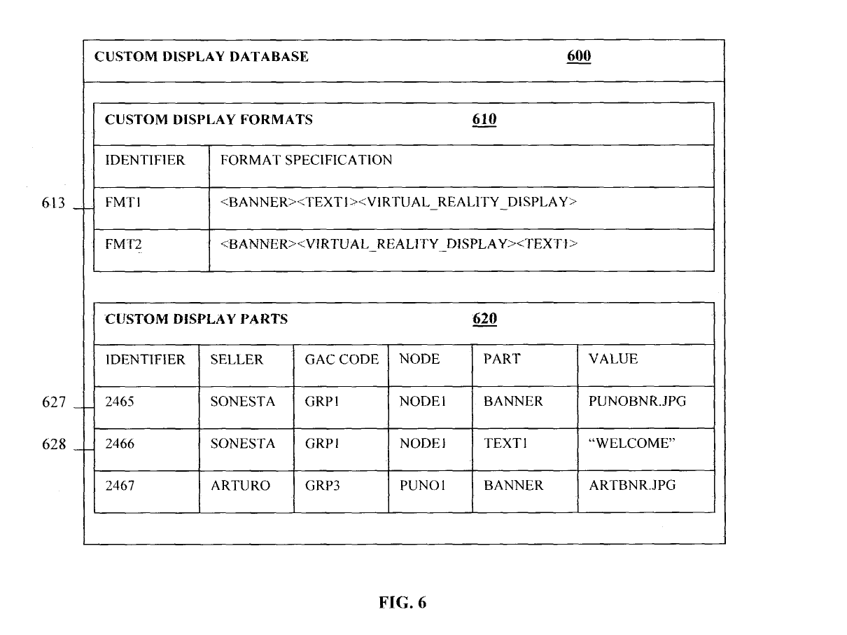

FIG. 6. The Display database 600 stores information controlling the representation of the virtual environment, including the seller locations and venues. The Display database contains Custom Display Formats 610, which control various presentation parameters, and Custom Display Parts 620, which defines portions of the differentiated content.

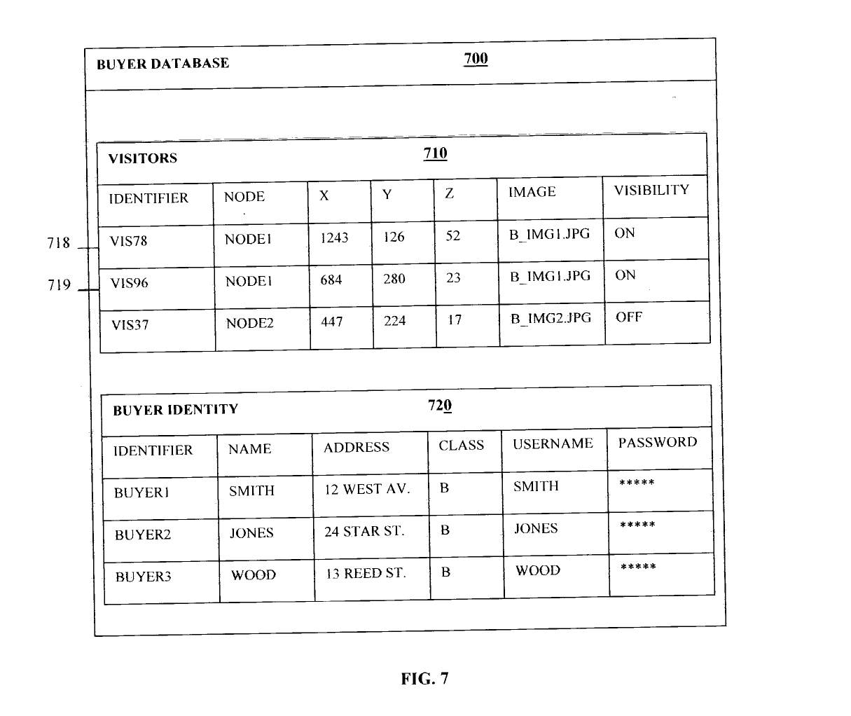

FIG. 7. The Buyer database 700 stores information on each buyer 110, 120,130 interacting with the virtual reality system, including location within the environment 710, and transaction-related information such as contact and billing information 720.

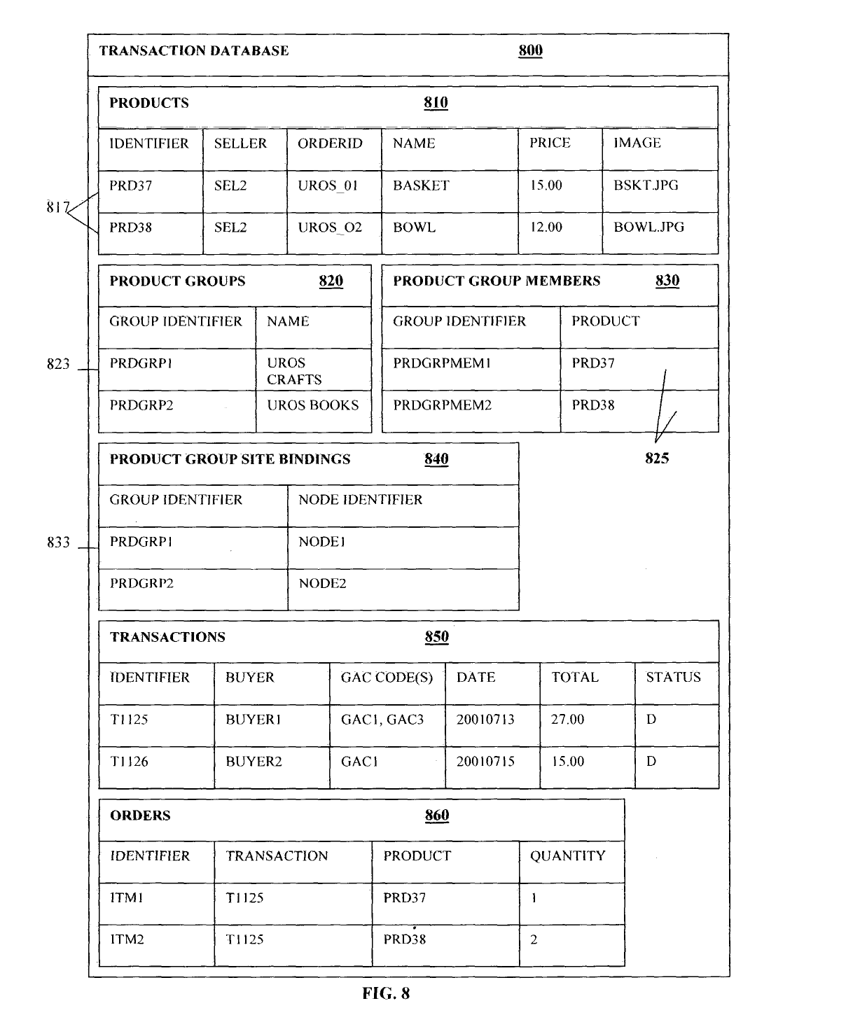

FIG. 8. The Transactions database 800 stores information on each product offered by each seller, including product grouping, price, inventory, product id, and additional rules pertaining to the sale of the product such as discount, applicable tax, and the like 810. The Transaction database 800 also stores information on product groupings 820, 830, as well as the associations between product groupings and locations within the virtual reality environment 840 that may be established by the seller.

In addition, the Transaction database 800 stores information on transactions 850 and orders 860, including the group affiliation codes of associated with the transaction.

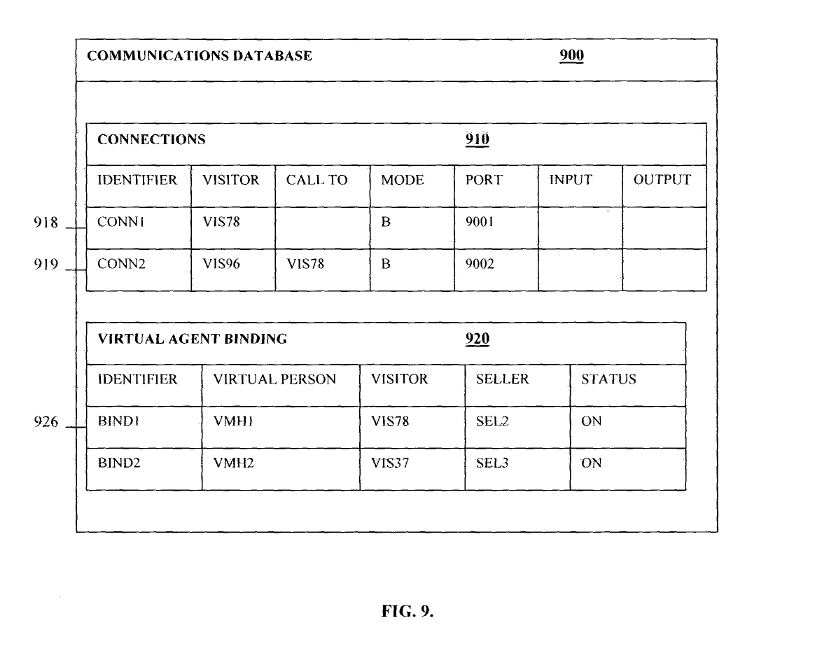

FIG. 9. The Communications database 900 stores information on each open channel of communication 910 established between buyers 110, 120, 130 and/or sellers 140, 150, 160. The Communications database also stores information on bindings between buyers 110, 120, 130 or sellers 140, 150, 160 and virtual agents defined in the Virtual Reality database 400. These bindings 920 allow the representations of virtual agents in the virtual reality environment to be used as mechanism for opening communication channels.

FIG. 10. The Processes for Inserting Content Into the Virtual Reality Environment of FIG. 2 illustrates an example of a process by which a seller first defines a grouping of products and then enters the virtual reality environment to organize the representations of these products within the representation of the virtual space. The seller first logs into a private account by submitting a unique username and corresponding password 1010. Upon entry, the seller receives a control interface 1020 which includes an option allowing him to create a Product Group record 823 in the Transactions database 800. Thereupon, he may access a portion of the control interface 1030 which allows him to create one or more Product Records 817 in the Product Table 810 of the Transactions database 800 which include descriptive information about the products. The seller may then enter the virtual reality environment and navigate to the location where the products are to appear to buyers 1040. A control interface mechanism 1050 allows the seller to request the import of a product group to that location in association with a Group Affiliation Code, whereupon the representations of all products in the group are inserted into the representation of the virtual space. This effectively creates a set of Node Linkage records 329 which associate the Product Records 817 to specific locations within the virtual reality environment under the access control of the indicated Group Affiliation Code. The seller may then use the control interface of the virtual environment 1060 to transfer these product representations within the space to their desired locations. The Node Linkage records 329 are modified accordingly when the seller indicates completion.

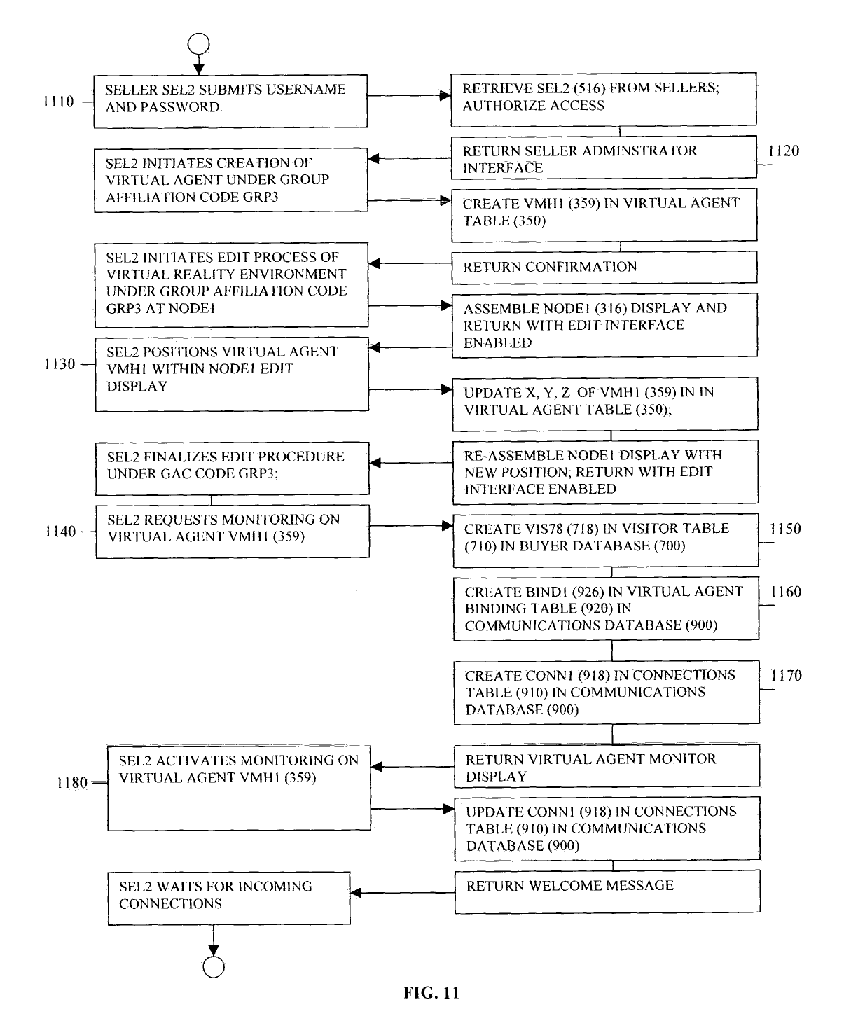

FIG. 11. The Processes for Creating and Monitoring Virtual Agents Within the Virtual Reality Environment of FIG. 2 illustrates an example of a process by which a seller may create and then monitor and communicate with buyers via a virtual agent placed within the virtual reality environment. The seller first logs into a private account by submitting a unique username and corresponding password 1110. Upon entry, the seller receives a control interface 1120 which includes an option allowing him to create a record in the Virtual Agent Table 350. This record contains the defining characteristics of a virtual agent with an associated Group Affiliation Code. Upon successful creation of this record, the seller then enters the Virtual Reality Environment carrying the appropriate Group Affiliation Code. With administrative authority, the seller is permitted to position the graphic representation of the virtual agent at a selected point within the represented Virtual Reality Environment 1130. The revised coordinates are saved in the Virtual Agent Table 350. The administrator interface allows the seller to activate a monitoring process on the virtual agent 1140. Upon this request, the program generates a Visitor ID record 718 in the Visitor Table 710, which provides a unique identifier for the seller, to be used in addressing and delivering communicated messages from other visitors in the Virtual Reality Environment 1150 The program then creates a record 1160 in the Virtual Agent Binding table 920. This record links the unique Visitor ID 718 with the virtual agent 359. Finally 1170, the program creates a record in the Connections Table 910, which maintains the networking information needed to deliver communicated messages to the seller's computer terminal 130. Thus the representation of the virtual agent as it appears in the display of the Virtual Reality Environment is linked via the Virtual Agent Binding table to a uniqueVisitor ID number which identifies the seller. This Visitor ID number is in turn associated with a network communication channel via the Connections Table allowing the system to transmit messages to and from the virtual agent to the seller. Upon completion of these steps, the program authorizes the seller to activate 1180 the connection to the virtual agent, whereupon all subsequent incoming messages directed through the virtual agent will be routed to the seller's control interface and all outgoing control messages from the seller will be routed to the Virtual Person. Such control messages may affect the display, positioning, attributes, or programmed behaviors of the Virtual Person. This embodiment of the invention further addresses applications wherein multiple sellers may be linked to a single Virtual Person, as in a customer service application requiring multiple operators to attend to multiple simultaneous buyers.

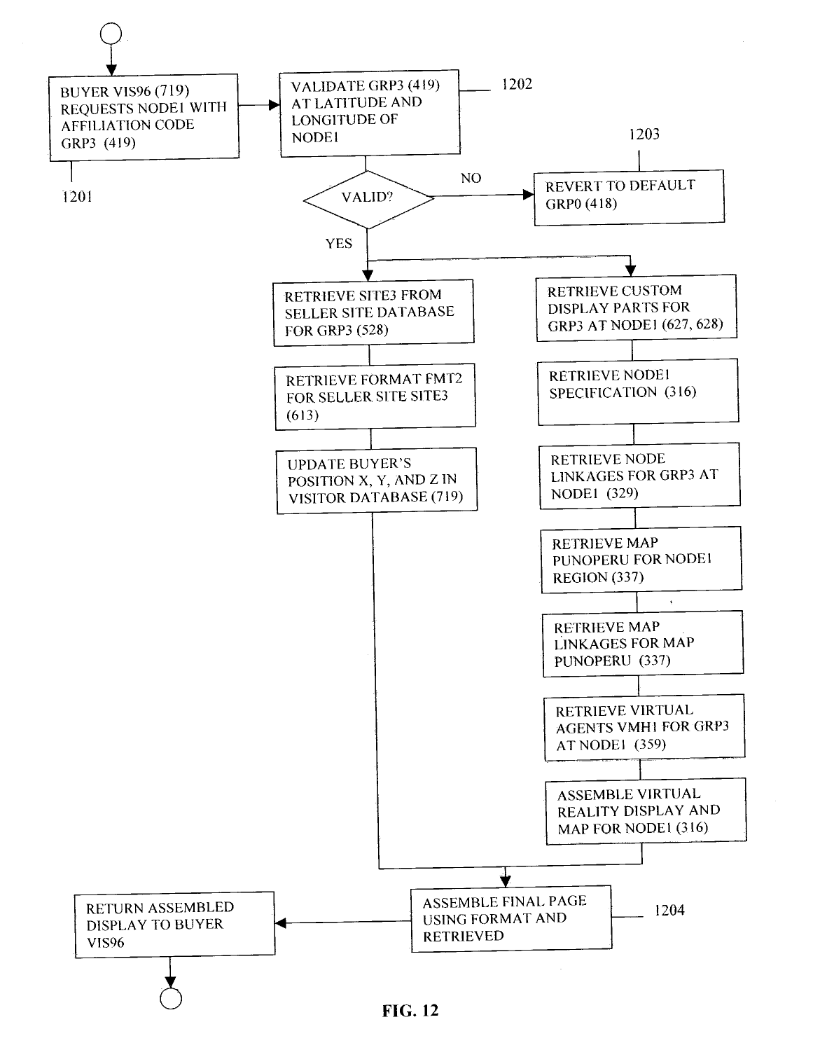

FIG. 12. The Processes for Rendering the Virtual Reality Environment of FIG. 2 illustrates an example of a process by which a visitor to the Virtual Reality Environment may receive a differentiated view of a seller's site within the environment with supplemental information. The buyer submits a request for a particular location within the environment specified by NODE1, together with a Group Affiliation Code 1201. The server first determines whether the Group Affiliation Code is applicable at the specified address 1202. If not, a default Group Affiliation Code is substituted 1203. Then, based on the applicable Group Affiliation Code, the various components required for the display are retrieved from the database. These include graphical materials to produce maps and representations of the environment at that location, together with differentiated content materials selected on the basis of the Group Affiliation Code. These materials are then assembled into a final representation which is returned to the visitor 1204.

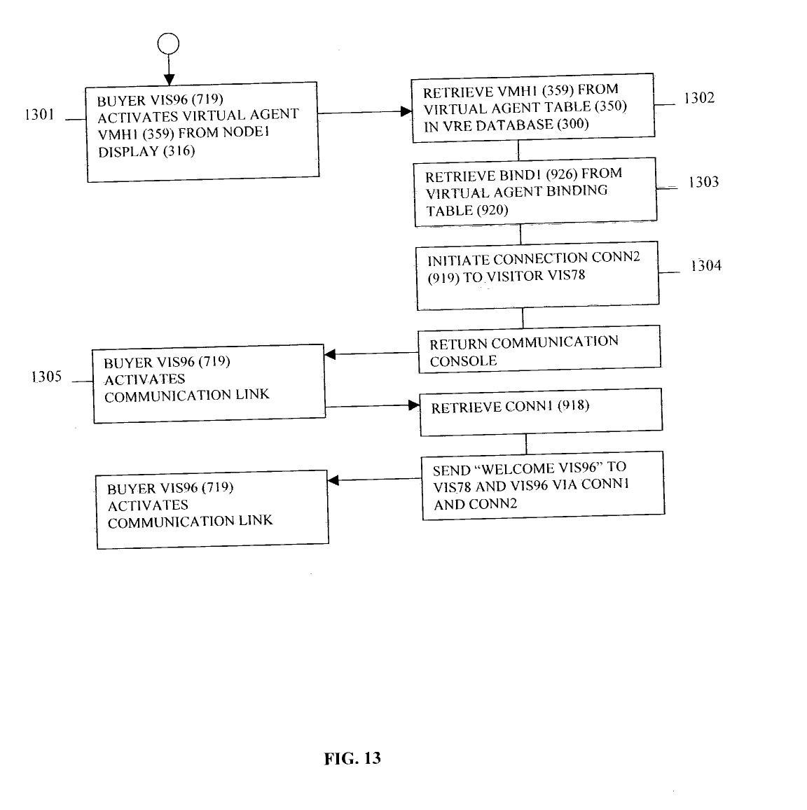

FIG. 13. The Processes for Communicating Within the Virtual Reality Environment of FIG. 2 illustrates an example of a process by which a buyer may initiate a communication process with a seller by interacting with a Virtual Person. Upon receipt of a representation of the Virtual Reality Environment containing a representation of a Virtual Person, according to processes as illustrated in FIG. 12, the buyer may activate the Virtual Person by means specified in the definition of the Virtual Person (such as clicking with a computer pointing device) 1301. Thereupon the server will retrieve the Virtual Person definition from the database 1302 and use a reference contained therein to retrieve an appropriate record from the Virtual Person Binding table 1303. This record in turn contains an active communication network address for the seller used to establish a direct communication link between buyer and seller 1304. The communication interface is activated on the buyer's computer console, whereupon the communication between buyer and seller may commence 1305. FIG. 13 illustrates a sample process in which the buyer must transmit the initial message; however, it is recognized that small variations in the process would permit either party to initiate transmission.

It is to be understood that the embodiments and variations shown and described herein are merely illustrative of the principles of this invention and that various modifications may be implemented by those skilled in the art without departing from the scope and spirit of the invention.

What is claimed is:

1. A system for presenting differentiated content in a virtual reality environment based on group affiliation, comprising:
a process for generating representations of a physical or imaginary multi-dimensional space that is responsive to a plurality of individual users requesting specific representations based upon a state, or location, within the space (hereinafter referred to as a virtual reality environment);
a process for receiving requests from and distributing representations of a virtual reality environment to a plurality of individual users;
a method for assigning one or more group affiliation codes to a plurality of individuals engaged in using the virtual reality environment;
a method for maintaining association between an individual and one or more group affiliation codes;
a method for terminating the association between an individual and a group affiliation code;
a method for modifying the rendition of the virtual reality environment through the addition or deletion of inserted content materials selected on the basis of group affiliation codes, where the inserted content materials may include but not be limited to information encoded as text, graphical imagery, audio, or video signals.

2. A system, according to claim 1, wherein the method for generating representations of the physical or imaginary space is effected by means of vector-based graphic systems rendered as ray-traced projections (including VRML or so-called 3-dimensional models);

3. A system, according to claim 1, wherein the method for generating representations of the physical or imaginary space is effected by means of raster-based images rendered as cylindrical or spherical projections (including panoramic photography);

4. A system, according to claim 3, wherein the method for generating representations of the physical or imaginary space is effected by means of a continuous sequence of raster-based images derived from digitally-encoded video signals and rendered as cylindrical or spherical projections;

5. A system, according to any of claims 1 through 4, wherein the method for receiving requests and distributing representations of a virtual reality environment is effected by means of a publicly accessible communications network such as the Internet;

6. A system, according to claims 1 through 5, further comprising a method for modifying the presentation of the virtual reality environment through the addition or deletion of supplemental content materials which may be presented to the user beside, above, below, or otherwise in conjunction with but not incorporated into the rendering of the multi-dimensional space of the virtual reality environment, and which may include (but not be limited to) information encoded as text, graphical imagery, audio, or video signals.

7. A system for creating and managing differentiated content for presentation both within the representation and supplemental to the representation of a virtual reality environment according to any of claims 1 through 6, comprising:
a method for defining group affiliation codes;
a method for defining text, image, audio, video, and other content elements for insertion within or for presentation supplemental to the rendering of a virtual reality environment;
a method for associating inserted and supplemental content with group affiliation codes;
a method for organizing and maintaining inserted and supplemental content such that it can be accessed and utilized by a system according to claim 1.

8. A system, according to any of claims 1 through 6, further comprising:
a method for defining and maintaining an order of precedence among a plurality of group affiliation codes associated with an individual user;
a method for selecting or not selecting inserted or supplemental content material on the basis of the precedence order among a plurality of group affiliation codes.

9. A system, according to claim 8, wherein the order of precedence among a plurality of group affiliation codes associated with an individual is determined on the basis of the temporal order in which the group affiliation codes became associated with the individual.

10. A system, according to any of claims 1 through 9, further comprising:
methods for creating, maintaining, modifying, and deleting a plurality of seller definitions comprising (but not limited to) name, address and other contact information, username, and password;
methods for creating, maintaining, modifying, and deleting a plurality of seller site definitions, where each such definition associates a region of the multi-dimensional space of a virtual reality environment according to claim 1 with one or more of the seller definitions;
methods for creating, maintaining, modifying, and deleting a plurality of product descriptions comprising (but not limited to) seller identifier, product name, text description, product images, price, and availability;
a method of organizing said product descriptions such that they can be accessed and utilized as inserted or supplemental content by systems according to claim 1 or its extensions or variations as described herein;
methods for associating and dissociating sets of one or more product definitions with a seller site;
methods for creating, maintaining, modifying, and deleting sets of one or more references to product descriptions;
methods allowing users of a virtual reality environment according to claim 1 to add and delete elements from such a set of product references, and to modify a quantity value associated with each element in the set;
methods for completing a sales transaction for products enumerated in such a set of product references.

11. A system, according to claim 10, wherein the method for adding a product reference to a set of product references is effected by means of activating or otherwise acting upon an element of inserted content within the representation of a virtual reality environment;

12. A system, according to any of claims 1 through 11, further comprising:
a method for receiving and transmitting messages, which may incorporate encoded text, graphic images, video, or audio signals, via a communication port at a fixed network address, herein referred to as a “message server”;
methods for establishing, maintaining, and terminating a series of message transmissions between a message server and an individual buyer or seller engaged in interaction with a virtual reality environment, the series hereinafter referred to as a “user connection”;
a method of addressing messages, such that the message server can retransmit messages that it receives to one or more user connections selected on the basis of the address.

13. A system, according to either of claim 12, further comprising:
a method wherein the virtual reality environment may be associated with an active user connection maintained by the message server such that a class of coded messages transmitted on that connection may be addressed to and received by the controlling process of the virtual reality environment;
a process enabling the virtual reality environment to interpret such encoded messages and respond by transmitting information as may be requested in a message, or by effecting one or more changes within the environment which may include (but not be limited to) altering the state parameters of the environment including those controlling location and direction of view, altering any of the inserted or supplemental content associated with the environment, or altering the current set of group affiliation codes controlling the presentation of the environment.

14. A system, according to claim 14, wherein some portion of the inserted content represents a “virtual person” or other form of dynamic agent, further comprising:
a method for creating definitions of dynamic agents which may comprise (but not be limited to) zero or more graphical representations of the agent or parts of the agent in the form of raster- or vector-based graphical imagery or video or a combination of these formats, zero or more elements of audio data, zero or more processes or actions that the agent may execute, a plurality of parameters of state including those sufficient to allow the dynamic agent to be accessed and utilized within the virtual reality environment;
a process for controlling dynamic agents, comprising a method for receiving and transmitting event signals and messages, a method for selecting and executing agent processes or actions based on the receipt of event signals, a method for selecting and delivering graphical representations of the agent, a method for selecting and delivering audio signals associated with the agent, and methods for changing the state parameters of the agent definition which may include those controlling the location of the agent within the state space of the virtual reality environment;
methods for modifying and deleting the definitions of dynamic agents;

15. A system, according to claim 14, wherein the agent-controlling process may be associated with an active user connection maintained by the message server such that a class of coded messages and event signals transmitted on that connection may be directed to and received from the agent-controlling process;

16. A system, according to claim 15, wherein the dynamic agent may be associated with a user definition;

17. A system, according to claim 16, wherein an individual user may establish a communication link with another user by activating a process of the dynamic agent associated with that user;

18. A system, according to claim 16, wherein an individual user may establish a communication link with another user or group of users by providing an identification code associated with that user or group of users;

19. A system, according to any of claims 1 through 18, further comprising:
a process for monitoring state transition sequences for a plurality of buyers engaged in interactions with the Virtual Reality System and recording selected events of interest as they may occur;
a method of defining sets of events of interest and associating them with a particular seller by means of a seller description identification code. Events of interest may include (but not be limited to) the transition of a buyer to a particular location, the acquisition by a buyer of a particular group affiliation code, or an action by a buyer to initiate a purchase, a request for information, or a dialog between buyer and seller;
a method of summarizing and reporting events of interest severally to a plurality of sellers, each according to the associated sets of events registered to their seller identification code.
